(19) United States
(12) Patent Application Publication
(10) Pub. No.: US 2015/0327532 A1
(43) Pub. Date: Nov. 19, 2015

(54) ARTHROPOD ABATEMENT SYSTEM

(71) Applicant: DWIGHT L WILLIAMS, ASHTON, MD (US)

(72) Inventor: DWIGHT L WILLIAMS, ASHTON, MD (US)

(21) Appl. No.: 14/712,909

(22) Filed: May 14, 2015

Related U.S. Application Data
(60) Provisional application No. 61/992,889, filed on May 14, 2014.

(51) Int. Cl. A01M 1/04; A01M 1/14; A01M 1/10

(52) U.S. Cl. CPC A01M 1/04; A01M 1/103; A01M 1/14

(57) ABSTRACT

Accordingly, one aspect of the present invention relates to a system for capturing arthropods comprising a housing including a first section and a second section, a substrate placed within the first section for preventing the arthropods from leaving the first section once the arthropods have entered the first section, and a light source enclosed within the second section of the housing for attracting arthropods to the first section, and position therein such that the light emitting from the light source is projected on the substrate. The second section comprises a transition point that separates the second section from the first section, and is circumferentially continuous such that the light source is enclosed therein, and the first section is a non-circumferentially continuous allowing arthropods to enter and land on the substrate contained therein.

### CROSS-REFERENCE TO RELATED APPLICATION

The present application is a U.S. nonprovisional patent application of, and claims priority under 35 U.S.C. §119(e) to, U.S. provisional patent application Ser. No. 61/992,889, filed May 14, 2014, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND

The present invention relates generally to insect traps. More specifically, the present invention relates to an arthropod trap that uses a light source.

There are several varieties of arthropod traps that use light as an attractant. These traps consistently have the light source as the focal point of the trap. Correspondingly, these traps have the immobilization surface to be present 360 degrees around the light source when observing from at least one projection.

These traps tend to have limitations. First, because the light is projected in all directions, the light is more diffuse than it could be if it was directed specifically onto the immobilization surface. Another limitation is that these traps are generally not configured in a way that optimizes accessibility to crawling arthropods.

Therefore, there exists a need for an improved abatement system.

### SUMMARY

The present invention includes many aspects and features. Moreover, while many aspects and features are described in, the present invention is not limited to use only in the disclosed context, as will become apparent from the following summaries and detailed descriptions of aspects, features, and one or more embodiments of the present invention.

Accordingly, one aspect of the present invention relates to a system for capturing arthropods comprising a housing including a first section and a second section, a substrate placed within the first section for preventing the arthropods from leaving the first section once the arthropods have entered the first section, and a light source enclosed within the second section of the housing for attracting arthropods to the first section, and position therein such that the light emitting from the light source is projected on the substrate. The second section comprises a transition point that separates the second section from the first section, and is circumferentially continuous such that the light source is enclosed therein, and the first section is a non-circumferentially continuous allowing arthropods to enter and land on the substrate contained therein.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWING(S)

A more detailed understanding of the disclosed system and method may be had from the following description, given by way of example and to be understood in conjunction with the accompanying drawing.

FIG. 1 is an example oblique view of an abatement system in accordance with a disclosed implementation of the present invention;

FIG. 2 is another oblique view of the abatement system of FIG. 1 including a view inside a section of the housing in accordance with a disclosed implementation of the present invention;

FIG. 3 is an oblique view of one embodiment of the arthropod abatement device;

FIG. 4 is a top view of the arthropod abatement device; and

FIGS. 5 and 6 are alternative embodiments of the device.

### DETAILED DESCRIPTION

Referring now to the drawings, one or more preferred embodiments of the present invention are next described. The following description of one or more preferred embodiments is merely exemplary in nature and is in no way intended to limit the invention, its implementations, or uses.

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

A disclosed abatement system attracts and immobilizes arthropods using a light source that is not the focal point of the system. In accordance with a disclosed implementation of the abatement system, the light source is positioned on the side of the system, so that the light from the light source is directed onto a substrate.

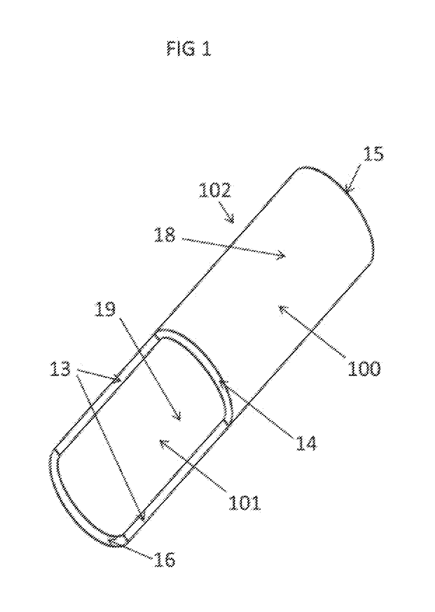

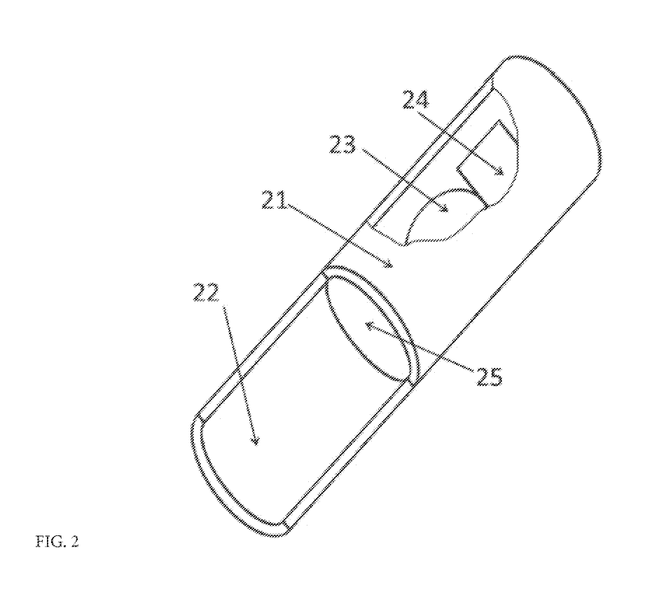

FIGS. 1 and 2 are example illustrations of an implementation of a disclosed abatement system 10. The abatement system 10 includes an housing 102 and a light source 23. The light source 23 may be enclosed in the housing 102 to protect the light source from the environment as well as focus the light source 23 in accordance with the disclosed implementation.

The housing 102 is preferably elongated, and includes an outer surface 18 and an inner surface 19, and at least two sections, a first section 101 and a second section 100. The housing 102 may be made from The housing 102 may have a thickness represented by 13. In accordance with the disclosed implementation, an axial transition point 14 separates the first section 101 from the second section 100 of the housing 102.

The first section 101 is preferably a non-circumferentially continuous portion of the housing 102, such that the inner surface 19 of the housing 102 is exposed to the environment, and includes an axial end 16 that preferably possesses no transverse barrier, allowing arthropods to enter the first section 101. As used herein non-circumferentially continuous may be any shape or structural arrangement with a cross-section that is not a closed loop, including but not limited to, two or three sides of a rectangle, any arcs that traverse less than 360 degrees, any spiral shapes, any parallel line segments, any curved or straight line segments that are oriented with respect to the same or differing axes, etc. In accordance with the disclosed implementation illustrated in FIGS. 1 and 2, the first section 101 is a partial moon shape section of the housing 102.

In accordance with the disclosed implementation, the inner surface 19 of the first section 101 may include a substrate 22 that is used to immobilize arthropods that have entered the first section 101. The substrate 22 may be any homogeneous or heterogeneous material and/or system that can immobilize an arthropod. It is preferable that the substrate 22 measure in length the same as the inner surface 19 of the first section 101. In the disclosed implementation, the substrate includes a immobilizing substance, for example, glue, petroleum jelly, syrup, etc. In other implementations, the substrate may include an immobilizing substance mounted on a rigid or quasi-rigid surface, for example, tape, fly paper, pest control glue boards, etc.

When in use, the substrate 22 preferably maintains a nominal thickness and can be distributed rather uniformly across a surface and/or several surfaces. It is preferable also that the substrate 22 be able to be changeable within the first section, such that a user is able to change the substrate when it is full of immobilized arthropods and/or use a different substrate to capture more or different types of arthropods.

Those having skill in the art should know that the type of substrate used and the location of the abatement system may affect the results obtained. Arthropod immobilization may occur almost instantaneously in some instances, and in other instances, the immobilization may occur over time as the arthropod expends energy in the substrate trying to escape.

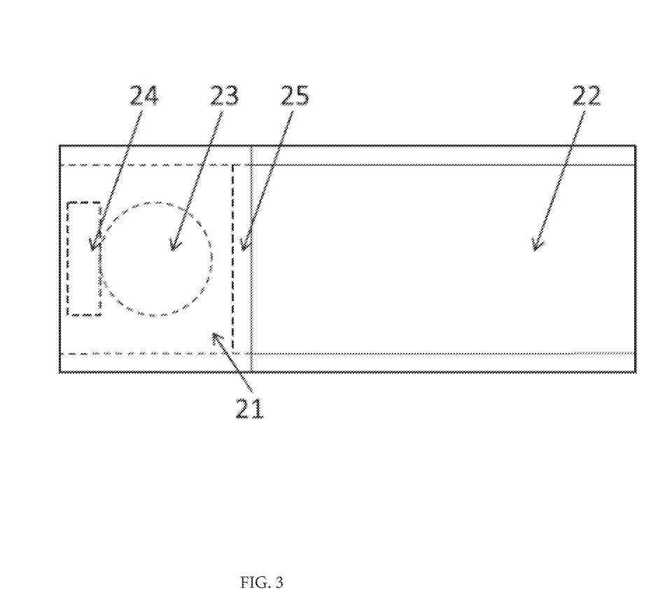

The second section 100 is preferably a circumferentially continuous portion of the housing 102 located between the transition point 14 and an axial end 15 of the circumferentially continuous portion of the housing 102. As illustrated in FIGS. 2 and 3, the light source 23 is enclosed in the second section 100. In accordance with the disclosed implementation, the second section 100 is a tubular integrated housing.

In an alternative implementation, an environmental and heat shield 25 may be included in the second section 100, located at the transition point 14. The shield 25 prevents arthropods from entering the second section 100, in which the light source is encased and protects the substrate 22 from the heat that may originate from the light source 23. The shield is intended to serve as a buffer between the light source 23 and the second section 100. Therefore, it is preferable that the shield 25 be placed circumferentially around the light source 23.

Alternatively, a transverse shield 25 may fit snugly within the second section 25 at the transition point 14. Therefore, the transverse shield 25 may have the same dimensions as the inner surface of the second section 100 at the transition point 14. In the implementation illustrated in FIGS. 2-4, the dimensions correspond to a shield 25 that is circular with a diameter of approximately 2″. The shield 25 is preferably thick enough to mitigate the heat escaping from the light source 23 towards the sticky surface 22. In the illustrated implementation, this corresponds to a thickness of 0.25″.

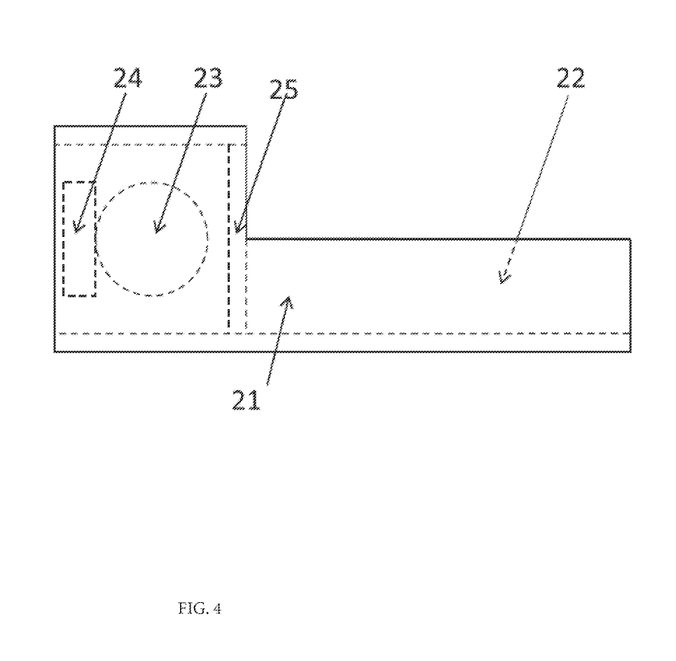

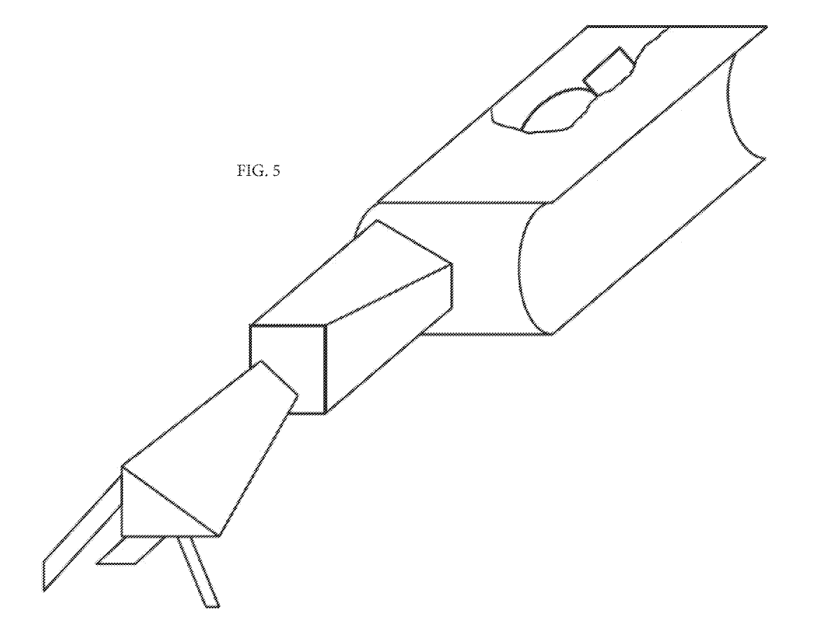

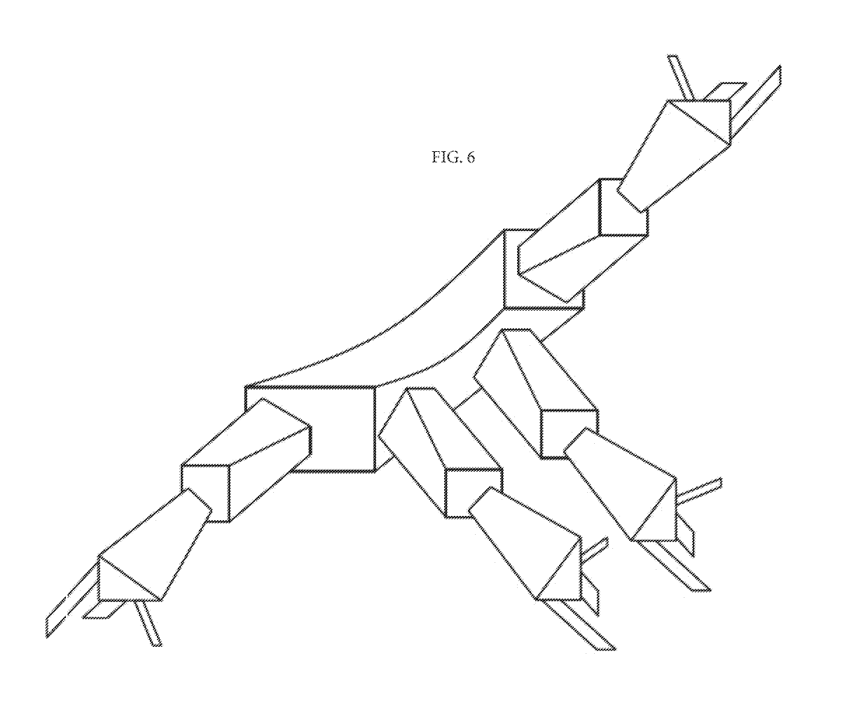

The light source 23, encased in the second section 100, is used to attract arthropods to the abatement system 10. The light source 23 must be able to fit completely within the circumferentially continuous portion of the housing 100. In addition, because the second section 100 serves as a collimator for the light traversing from the light source 23 to the substrate 22, the length of the light source 23 may be such that it can reside recessed (i.e., be positioned between 14 and 15 in FIG. 1) within the second section 100. Additionally, the light source 23 radius must be smaller than the inner radius of the second section 100. In the example implementation illustrated in FIGS. 3 and 4, the length of the light source 23 is approximately 4″ long and 1.75″ in diameter.

In the implementation of the system 10 illustrated in FIGS. 1 and 2, the housing 102 originates as a standard hollow tube. The inner tube 19 diameter is approximately 2″ in the illustrated example, and the outer tube 18 diameter is approximately 2.5″. The total housing length is approximately 12″. The length of the circumferentially continuous portion of the housing 100 is approximately 5″ and the length of the non-circumferentially continuous portion of the housing 101 is approximately 7″. The first section 101, non-circumferentially continuous portion of the housing 102 spans approximately 180° which corresponds to an inner linear distance of approximately 6.25″.

The substrate 22 measures as the same dimensions as the inner surface dimensions of the non-circumferentially continuous portion of the housing 101. In the case of the implementation shown in FIGS. 3 and 4, this corresponds to a sticky surface length of approximately 7″ and a sticky surface width of approximately 6.25″. Because the sticky surface 22 serves as an attractant to the arthropods, it is preferable that the inner surface 19 be white or near-white, if the substrate is opaque. If the inner surface of the housing 102 is white or near white, then the substrate 22 may be transparent.

The abatement system 10 is designed to work by the light source 23 projecting light through the transition point 14 of the housing onto the substrate 22. Light that does not terminate on the sticky surface is projected into the environment of the arthropod abatement system 10. Based on the customary usage and orientation of this implementation of the system, the environment will normally consist of a ceiling, a wall, a floor, the ground, or some other support structure or system. Arthropods are attracted to the device via the light projected directly from the light source 23, the light reflected from the substrate 22, and light reflected from the environment of the system.

When arthropods enter the immediate vicinity of the system, the overwhelming sources of light originate from the light source 23 and the light reflecting from the substrate 22. Arthropods attracted directly to the substrate 22 will be immobilized by the surface. Arthropods attracted to the light source 23 will be immobilized by the adjacent substrate 22 as the arthropods crawl around the light source 23 opening, the transition point 14.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A system for capturing arthropods comprising:
a housing including a first section and a second section;
a substrate placed within the first section for preventing the arthropods from leaving the first section once the arthropods have entered the first section; and
a light source enclosed within the second section of the housing for attracting arthropods to the first section, and position therein such that the light emitting from the light source is projected on the substrate;
wherein the second section comprises a transition point that separates the second section from the first section, and is circumferentially continuous such that the light source is enclosed therein, and
wherein the first section is a non-circumferentially continuous allowing arthropods to enter and land on the substrate contained therein.
